(19) United States
(12) Patent Application Publication
(10) Pub. No.: US 2020/0029114 A1
(43) Pub. Date: Jan. 23, 2020

(54) METHOD, SYSTEM, AND NON-TRANSITORY COMPUTER-READABLE RECORD MEDIUM FOR SYNCHRONIZATION OF REAL-TIME LIVE VIDEO AND EVENT DATA

(71) Applicant: Snow Corporation, Seongnam-si (KR)

(72) Inventors: Mun Heon Kim, Seongnam-si (KR); Wooseok Park, Seongnam-si (KR); Geol Heo, Seongnam-si (KR)

(73) Assignee: Snow Corporation, Seongnam-si (KR)

(21) Appl. No.: 16/518,040

(22) Filed: Jul. 22, 2019

(30) Foreign Application Priority Data
Jul. 23, 2018 (KR) 10-2018-008557 4

(51) Int. Cl. H04N 21/43; H04N 21/2187; H04N 21/845; H04N 21/242

(52) U.S. Cl. CPC H04N 21/4302; H04N 21/242; H04N 21/8456; H04N 21/2187

(57) ABSTRACT

Data synchronization methods performed by a computer system including at least one processor configured to execute computer readable instructions included in a memory, and including receiving, by the at least one processor, first data and second data from a server through real-time streaming, the second data being associated with the first data, and synchronizing, by the at least one processor, the first data and the second data using a timestamp included in the first data, and outputting, by the at least one processor, the synchronized first and second data may be provided.

### CROSS-REFERENCE TO RELATED APPLICATION(S)

This U.S. non-provisional application claims the benefit of priority under 35 U.S.C. § 119 to Korean Patent Application No. 10-2018-0085574 filed on Jul. 23, 2018, in the Korean Intellectual Property Office (KIPO), the entire contents of which are incorporated herein by reference.

### BACKGROUND

### Field

One or more example embodiments relate to technology for synchronizing a real-time live video and an event.

### Description of Related Art

With the improvement in performance of a mobile terminal, such as a smartphone, and development of mobile communication technology, it is possible to use a variety of contents, for example, photos, videos, audios, and applications, through access to a web server provided from a contents provider (CP).

In a current internet environment, various types of video services are provided and demands for high-definition live broadcasting are increasing accordingly. Also, demands for real-time streaming services are on the explosive increase.

### SUMMARY

According to an aspect of at least one example embodiment, a data synchronization method performed by a computer system including at least one processor configured to execute non-transitory computer readable instructions included in a memory includes receiving, by the at least one processor, first data and second data from a server through real-time streaming, the second data being associated with the first data, and synchronizing, by the at least one processor, the first data and the second data using a timestamp included in the first data, and outputting, by the at least one processor, the synchronized first and second data.

The timestamp may be included in timed metadata defined in the first data as an absolute time, and a pop time in the second data may correspond to for outputting the second data.

The pop time may be a value accounting for a compensation value according to a latency of the first data.

The data synchronization method may further include performing, by the at least one processor, a time synchronization with the server by receiving an absolute time that is a reference time for synchronizing the first data and the second data from the server.

The outputting may output the second data regardless of the first data, in response to a time gap between a first point in time at which the first data is received and a second point in time at which the second data is received reaching a critical time.

The critical time may be in the second data indicating a due time for outputting the second data.

The synchronizing may include periodically requesting the server for synchronization of the first data, and receiving a refresh request for the first data from the server as a response to the periodically requesting.

The synchronizing may include receiving a refresh request for the first data from the server as a response to the periodically requesting in response to a time gap between the first data transmitted to the server and the first data recently received by the at least one processor from the server being greater than or equal to a critical time.

According to an aspect of at least one example embodiment, a data synchronization method performed by a computer system including at least one processor configured to execute computer-readable instructions included in a memory includes receiving, by the at least one processor, a video stream and event data associated with the video stream from a server through real-time streaming, synchronizing, by the at least one processor, the video stream and the event data using a timestamp included in the video stream, and outputting, by the at least one processor, a result of the synchronizing the video stream and the event data.

In a network environment with a pulling structure of downloading the video stream and the event data from the server, the synchronizing and outputting the video stream and the event data may include outputting an event layer that includes the event data in response to play of the video stream reaching the timestamp.

The timestamp may be included in timed metadata defined in the video stream as an absolute time, and a pop time in the event data as for outputting the event data may corresponds to the timestamp.

The outputting the video stream and the event data may output the event data regardless of the video stream, in response to a time gap between a first point in time at which the video stream is received and a second point in time at which the event data is received reaching a critical time that is in the event data.

According to an aspect of at least one example embodiment, a non-transitory computer-readable record medium storing instructions that, when executed by the at least one processor, cause the at least one processor to perform the data synchronization method may be provided.

According to an aspect of at least one example embodiment, a computer system includes a memory, and at least one processor configured to connect to the memory and to execute computer-readable instructions included in the memory. The at least one processor may be configured to receive first data and second data associated with the first data from a server through real-time streaming, output the first data and the second data using a timestamp included in the first data, and output the synchronized first and second data.

According to some example embodiments provide, accurate synchronization may be supported by providing event data at a desired (or alternatively, predetermined) timing of a real-time live video.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 illustrates an example of a network environment according to at least one example embodiment;

FIG. 2 illustrates an example of an electronic device and a server according to at least one example embodiment;

FIG. 3 illustrates an example of a system environment for a live broadcasting service according to at least one example embodiment;

FIG. 4 is a flowchart illustrating an example of a live broadcasting service process according to at least one example embodiment;

FIG. 5 illustrates an example of outputting an event layer on a broadcast video according to at least one example embodiment;

FIG. 6 illustrates an example of an event data format according to at least one example embodiment;

FIG. 7 illustrates an example of a video stream data format according to an example embodiment; and

FIGS. 8 to 10 illustrate examples of a process of synchronizing a video stream and a video according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described. For example with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable record media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable record media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blue-ray/DVD/CD-ROM drive, a memory card, and/or other like computer readable record media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for accurately synchronizing a real-time live video and an event.

The example embodiments including the detailed disclosures may perform an accurate synchronization of a real-time live video at an event providing timing, which may lead to achieving many advantages in terms of quality of service (QoS), accuracy, efficiency, and convenience.

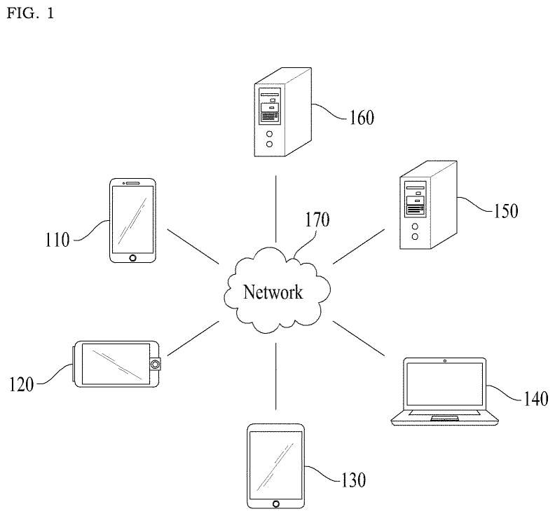

FIG. 1 is a diagram illustrating an example of a network environment according to at least one example embodiment. Referring to FIG. 1, the network environment includes a plurality of electronic devices 110, 120, 130, and 140, a plurality of servers 150 and 160, and a network 170. FIG. 1 is provided as an example only and thus, a number of electronic devices and/or a number of servers are not limited thereto.

Each of the plurality of electronic devices 110, 120, 130, and 140 may be a fixed terminal or a mobile terminal configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, and an augmented reality (AR) device. For example, although FIG. 1 illustrates a shape of a smartphone as an example of the electronic device 110, the electronic device 110 may refer to one of various physical computer systems capable of communicating with other electronic devices 120, 130, and 140, and/or the servers 150 and 160 over the network 170 in a wired communication manner or in a wireless communication manner.

The communication scheme is not particularly limited and may include a communication method using a near field communication between devices as well as a communication method using a communication network, for example, a mobile communication network, the wired Internet, the wireless Internet, a broadcasting network, and a satellite network, which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, it is only an example and example embodiments are not limited thereto.

Each of the servers 150 and 160 may be configured as a computer apparatus or a plurality of computer apparatuses that provides instructions, codes, files, contents, services, and the like through communication with the plurality of electronic devices 110, 120, 130, and 140 over the network 170. For example, the server 150 may be a system that provides a first service to the plurality of electronic devices 110, 120, 130, and/or 140 over the network 170, and the server 160 may be a system that provides a second service to the plurality of electronic devices 110, 120, 130, and/or 140 over the network 170. For example, the server 150 may provide a service, for example, a live broadcasting service, desired by a corresponding application as the first service to the plurality of electronic devices 110, 120, 130, and/or 140 through the application of the computer program installed and executed on the plurality of electronic devices 110, 120, 130, and/or 140. As another example, the server 160 may provide a service for distributing a file for installing and executing the application to the plurality of electronic devices 110, 120, 130, and/or 140 as the second service.

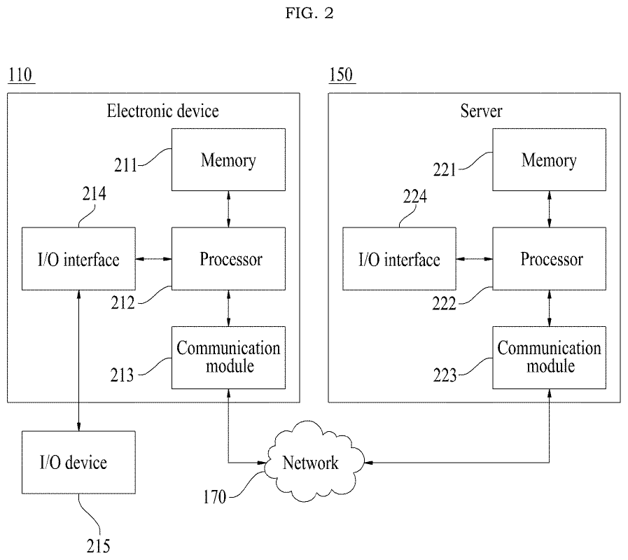

FIG. 2 is a block diagram illustrating an example of an electronic device and a server according to at least one example embodiment. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device, such as random access memory (RAM), a read only memory (ROM), a disk drive, a solid state drive (SSD), and a flash memory, as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS or at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication module 213, 223, instead of, or in addition to, the non-transitory computer-readable record medium. For example, at least one program may be loaded to the memory 211, 221 based on a computer program, for example, the application, installed by files provided over the network 170 from developers or a file distribution system, for example, the server 160, which provides an installation file of the application.

The processor 212, 222 may be configured to process computer-readable instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request created based on a program code stored in a storage device, such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a record medium further includable in the electronic device 110.

The I/O interface 214 may be a device used for interface with an I/O device 215. For example, an input device may include a device, such as a keyboard, a mouse, a microphone, and a camera, and an output device may include a device, such as a display, a speaker, and a haptic feedback device. As another example, the I/O interface 214 may be a device for interface with an apparatus in which an input function and an output function are integrated into a single function, such as a touchscreen. The I/O device 215 may be configured as a single device with the electronic device 110. Also, the I/O interface 224 of the server 150 may be a device for interface with an apparatus (not shown) for input or output that may be connected to the server 150 or included in the server 150. For example, when processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a number of components greater or less than a number of components shown in FIG. 2. However, there is no need to clearly illustrate many components according to the related art. For example, the electronic device 110 may include at least a portion of the I/O device 215, or may further include other components, for example, a transceiver, a global positioning system (GPS) module, a camera, a variety of sensors, a database (DB), and the like. For example, if the electronic device 110 is a smartphone, the electronic device 110 may be configured to further include a variety of components, for example, an accelerometer sensor, a gyro sensor, a camera module, various physical buttons, a button using a touch panel, an I/O port, a vibrator for vibration, etc., which are generally included in the smartphone.

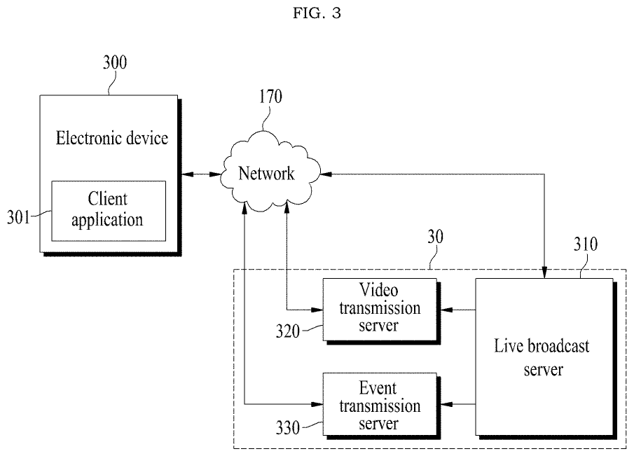

FIG. 3 illustrates an example of a system environment for a live broadcasting service according to at least one example embodiment.

FIG. 3 illustrates an electronic device 300 and a broadcasting service system 30 that includes a live broadcast server 310, a video transmission server 320, and an event transmission server 330. Each of the live broadcast server 310, the video transmission server 320, and the event transmission server 330 may be a device that includes the same or similar components as the server 150 of FIGS. 1 and 2. Also, the electronic device 300 may be a device that includes the same or similar internal components as the electronic device 110 of FIGS. 1 and 2. Although FIG. 3 illustrates that each of the live broadcast server 310, the video transmission server 320, and the event transmission server 330 is implemented by a single server, each of such servers may be provided in a form of a plurality of server groups. For example, with respect to the video transmission server 320 and the event transmission server 330, a number of servers desired may be determined based on a performance issue such as a number of simultaneously accessing users (or alternatively, a number of concurrent users).

A client application 301 installed in the electronic device 300 may be connected to the live broadcast server 310, the video transmission server 320, and the event transmission server 330 of the broadcasting service system 30 over the network 170. The live broadcast server 310 may be connected to and interwork with the video transmission server 320 and the event transmission server 330 through an internal network (not shown) or an external network (not shown). The video transmission server 320 and the event transmission server 330 may serve to receive data provided from the live broadcast server 310 and transmit the received data to the electronic device 300.

The client application 301, as an application produced using an open application programming interface (API), may be software or may be with a combination of software and hardware. The client application 301 refers to an application that is produced and distributed by the live broadcast server 310 or an application program developer (not shown) and that uses digital contents provided from the live broadcast server 310. Here, the digital contents may be live videos and VOD contents as video contents that are produced or processed in a digital format for a live broadcasting service.

The live broadcast server 310 may create and supply video content and may be, for example, a server or a plurality of server configured and/or operated by a studio or an outsourcing production company to provide a live broadcasting service. The live broadcast server 310 may provide the created video content to the video transmission server 320 and event data associated with the video content to the event transmission server 330. Here, a providing route may be implemented online or offline. The live broadcast server 310, the video transmission server 320, and the event transmission server 330 may be operated by a single provider, or may be operated by a plurality of providers, respectively.

Hereinafter, an example embodiment is described by taking a live quiz show as a representative example of the live broadcasting service.

The live broadcast server 310 is configured to transmit a broadcast video for the live quiz show. Thus, the live broadcast server 310 may provide the broadcast video to the video transmission server 320 and event data associated with the broadcast video to the event transmission server 330. Here, the event data may include information content associated with the broadcast video. For example, the event data may include a quiz including a question and alternative choices, a correct answer, a hint, an intermediate advertisement, and/or any type of events synchronized with a video may be applied.

The client application 301 may be stored in a memory (e.g., the memory 211 in FIG. 2) of the electronic device 300, and may implement a function of providing a live broadcasting service that is a unique service in conjunction with the broadcasting service system 30.

The video transmission server 320 may be a media source device including an encoder (not shown) configured to provide live stream data. The video transmission server 320 may provide the broadcast video provided from the live broadcast server 310 to the electronic device 300 as live stream data, that is, a real-time live video. The real-time live video provided from the video transmission server 320 may be played at the electronic device 300 through the client application 301, and may be provided to a user of the electronic device 300.

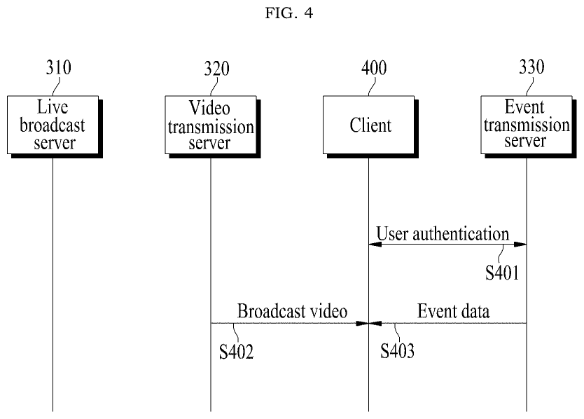

FIG. 4 is a flowchart illustrating an example of a live broadcasting service process, for example, a process of servicing a live quiz show, according to at least one example embodiment. A client 400 corresponds to the electronic device 300 in which the client application 301 is installed. The client 400 may be any fixed or mobile terminal configured as a computer system.

Referring to FIG. 4, in operation 5401, the client 400 may perform a user authentication through a log-in scheme using, for example, an ID and a password through the event transmission server 330. Thus, the client 400 may be granted with a right to use a service from the event transmission server 330, and a connection between the client 400 and the broadcasting service system 30 may be established. Although it is described that the client 400 is granted with the right to use the service from the event transmission server 330, it is provided as an example only. The authentication may be performed using the live broadcast server 310 or the video transmission server 320.

In response to a success in the user authentication of the client 400, the video transmission server 320 may transmit a broadcast video provided from the live broadcast server 310 to the client 400 through a real-time live streaming scheme in operation S402. Here, for example, an HTTP live streaming (HLS), a real-time messaging protocol (RTMP), a real-time streaming protocol (RTSP), a real-time transport protocol (RTP), or a real-time transport control protocol (RTCP) may be used as a transport protocol for real-time live streaming of the broadcast video.

In operation S403, the event transmission server 330 may transmit, to the client 400, event data associated with the broadcast video provided from the live broadcast server 310. Here, the client 400 may output event data to map the broadcast video through synchronization with the broadcast video being played.

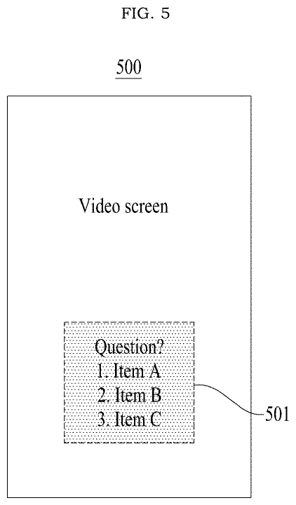

The broadcast video provided from the video transmission server 320 through real-time live streaming may be played at the client 400 and an event layer that includes the event data provided from the event transmission server 330 may be output on a screen on which the broadcast video is being played at a desired (or alternatively, predetermined) timing through synchronization during a process of playing the broadcast video. For example, referring to FIG. 5, the client 400 may pop up, and thereby display an event layer 501 that includes a question and alternative choices of a quiz on a video screen 500 on which a broadcast video of a live quiz show is being played.

To service the live quiz show, it is desired to accurately synchronize event data of a quiz, a correct answer, and a hint, with an event layer at a desired (or alternatively, predetermined) timing during playing a real-time live video.

Hereinafter, a method and system for synchronizing a real-time live video and an event according to example embodiments is described.

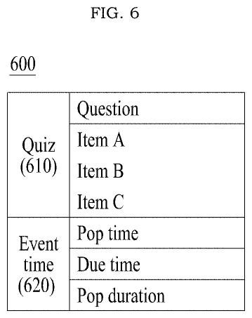

FIG. 6 illustrates an example of event data according to at least one example embodiment.

Referring to FIG. 6, when an event is assumed as a quiz, event data 600 may include, for example, a quiz 610 and an event time 620 as event objects. The quiz 610 may include a question and alternative choices (e.g., items A, B, and C), and the event time 620 may include time information associated with output of an event layer. For example, the event time 620 may include a pop time for outputting the quiz 610 in a video, a due time by which popping the quiz (e.g., quiz output) is allowed, and a pop duration during which the quiz output is maintained.

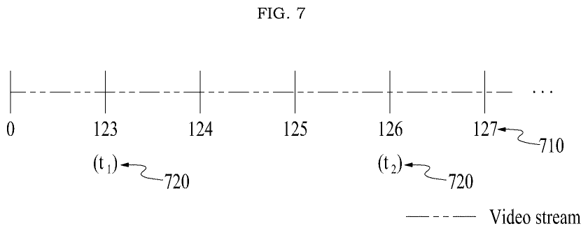

FIG. 7 illustrates an example of a video stream data format according to an example embodiment.

Referring to FIG. 7, timed metadata is defined in a video stream. Here, the timed metadata may be defined by dividing video stream data into segments each with a desired size based on a transport protocol, and by designating a metadata file for each segment. A relative sequence 710 indicating in-video time information for each section may be included in the timed metadata.

To synchronize a real-time live video and an event, a time value used for the event time 620 is desired. Here, the event time 620 may be compared to a time that is defined in the video. To use as a reference time value, an absolute time needs to be defined in the timed metadata in the video. Here, switching to a timestamp 720 that is the absolute time may be performed by referring to the relative sequence 710 included in the timed metadata.

The timestamp 720 indicating a time at which a quiz event layer is to be displayed may be included in the timed metadata defined in the video stream. By using the timestamp 720 included in the timed metadata, a point in time at which a specific segment of the video is created in the absolute time may be identified, and the quiz event layer may be displayed through accurate synchronization.

In a network environment in a pulling structure in which data is downloaded from a server (e.g., an HTTP live streaming (HLS)), data synchronization may be effectively performed by comparing absolute times of different pieces of data.

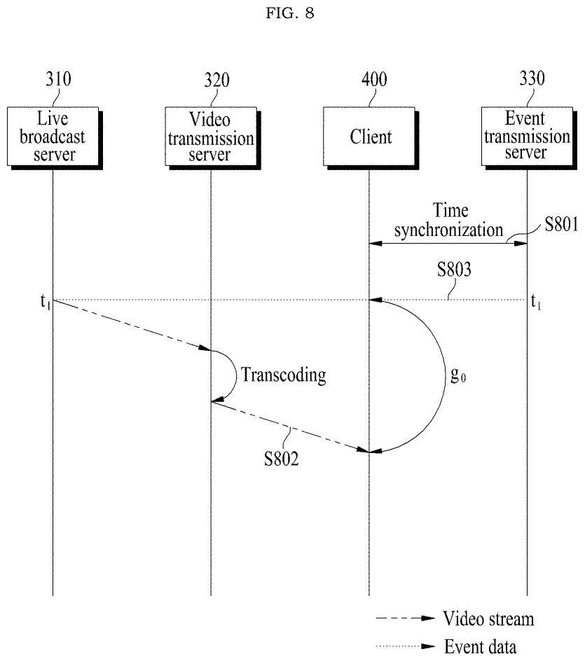

FIG. 8 is a flowchart illustrating an example of a process of synchronizing a real-time live video and an event according to at least one example embodiment.

Referring to FIG. 8, once a connection with the client 400 is established, the event transmission server 330 may provide an absolute time that is a reference time for the client 400 in operation 5801. In addition to the event transmission server 330, the live broadcast server 310 or the video transmission server 320 may provide the absolute time to the client 400. In some example embodiments, in addition to the live broadcast server 310, the video transmission server 320, and the event transmission server 330, the absolute time by a Unix standardization may be provided to the client 400 through a separate time server (not shown).

In response to a success in a user authentication of the client 400, the live broadcast server 310, the video transmission server 320, or the event transmission server 330 may synchronize the reference time for the client 400. The client 400 may perform time synchronization with the event transmission server 330 by executing a timer based on the absolute time provided from the event transmission server 330. Accordingly, synchronization of the real-time live video and the event may be processed based on a time (e.g., the event time 620) unified with (or alternatively, stored in) the event transmission server 330 without depending on an environment of the client 400 and a time value set to the client 400.

When the time synchronization is completed, the video transmission server 320 may transmit a video stream of a broadcast video to the client 400 in operation S802, and the event transmission server 330 may transmit event data associated with the broadcast video to the client 400 in operation S803.

In FIG. 8, a case in which an event layer is output at a point in time at which a section corresponding to an absolute time t₁ starts to play in the broadcast video is assumed.

A time gap between points in times at which different two pieces of data are received may occur based on a data characteristic. That is, a time gap gₒ may occur between a point in time at which the video stream is received at the client 400 and a point in time at which event data is received at the client 400.

To resolve the above issue, an event output may be delayed and an event layer may be output at a point in time at which a video corresponding to tᵢ may be actually played at the client 400.

A pop time of the event data for outputting the event data may be set to correspond to the timestamp 720. For example, a pop time of event data to be output at t₁ of a video may be set as t₁ (pop time=t₁), and an event layer including event data of which a pop time may be set to t₁ is output when playing of the video reaches t₁. Output of the event layer may be maintained during a pop duration that is set to the corresponding event data.

The pop time of the event data may be set considering all of delay times, for example, a time at which the broadcast video is transmitted from the live broadcast server 310 to the video transmission server 320 and a time at which the broadcast video is transcoded at the video transmission server 320. Accordingly, the pop time of the event data may be set by reflecting a compensation time t_{c} according to the delay time, for example, pop time=t₁′, t₁′=t₁+t_{c}.

Accordingly, the client 400 may accurately synchronize the event layer at a desired (or alternatively, predetermined) time of the broadcast video based on an absolute time set to each of the video stream and the event data, and thereby output the event layer.

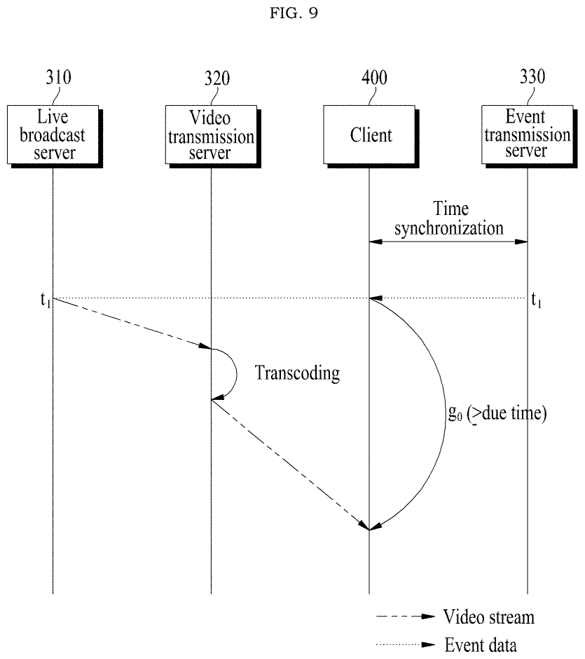

FIG. 9 is a flowchart illustrating another example of a process of synchronizing a real-time live video and an event according to at least one example embodiment. FIG. 9 also assumes a case in which an event layer is output at a point in time at which a section corresponding to an absolute time t₁ starts to play in the broadcast video, similar to FIG. 8.

Based on a network environment, a time used for the client 400 to receive a video stream may vary. Because the network environment is different for each client using a live quiz show, a time at which the video stream is received may differ.

Referring to FIG. 9, the client 400 may compare a time gap go between a point in time at which the video stream is received and a point in time at which event data is received to a due time corresponding to a critical time and, when the time gap go is greater than or equal to the due time, may output the event layer that includes event data of which the due time is set to t₁ regardless of playing of the broadcast video. That is, the client 400 may unconditionally output the event layer at a point in time at which the time gap gₒ between the point in time at which the video stream is received and the point in time at which the event data is received reaches the critical time. Output of the event layer is maintained during a pop duration set to the corresponding event data.

Accordingly, although the video stream is not ordinarily received due to the network environment, the client 400 may output the event layer at the due time set to the event data.

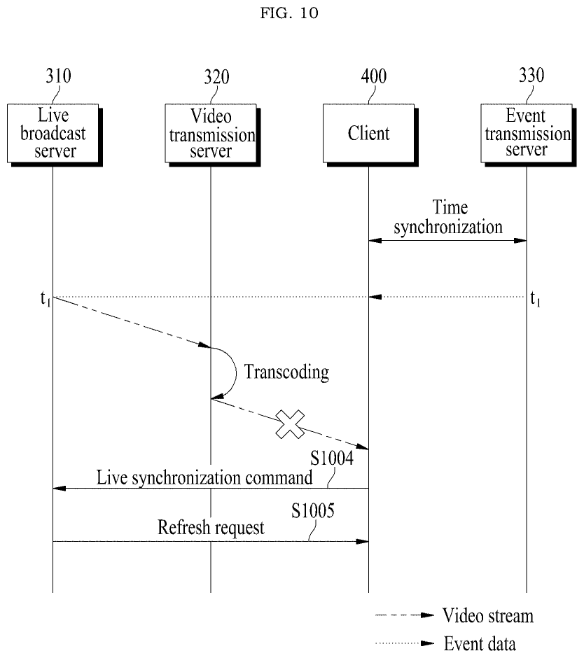

FIG. 10 is a flowchart illustrating another example of a process of synchronizing a real-time live video and an event according to at least one example embodiment.

The live broadcast server 310 may continuously monitor a segment corresponding to the video stream transmitted to the video transmission server 320 in the video, and the client 400 may periodically transmit (or alternatively, request), to the live broadcast server 310, a live synchronization command requesting information about a recently received segment in operation S1004. For example, the client 400 may request the live broadcast server 310 for live synchronization at desired (or alternatively, predetermined) intervals in preparation for a case in which the video stream is not received from the video transmission server 320.

In operation S1005, the live broadcast server 310 may determine refresh as a response to the live synchronization command transmitted from the client 400, and may transmit the refresh request to the client 400. When a time gap between a section transmitted to the video transmission server 320 from the live broadcast server 310 and a segment recently (or alternatively, most recently) received by the client 400 is greater than or equal to a desired (or alternatively, predetermined) critical time, for example, 13 seconds with respect to the broadcast video being transmitted, the live broadcast server 310 may request the client 400 for refresh. In other words, the live broadcast server 310 may provide a refresh request for a video or a video stream to the client 400, and the client 400 receives the refresh request for the video or the video stream from the live broadcast server 310 as a response to periodically requesting the live broadcast server 310 for synchronization of the video or the video stream. The critical time that is a reference time used to determine whether to perform refresh may be determined based on a service characteristic, for example, a subsequent quiz display time.

The client 400 may discard previously received data in response to the refresh request from the live broadcast server 310, and may perform again the process including operations S801 to S803 of FIG. 8.

According to example embodiments, in the case of displaying the event layer while playing the broadcast video of the live quiz show, the client 400 may accurately synchronize and thereby display the event layer at a point in time at which a segment with an inserted timestamp plays in a video.

Although synchronization of a real-time live video and event data is described above, it is provided as an example only. Example embodiments may apply in any case in which a plurality of pieces of data, for example, first data and second data associated with the first data, each having a different data arrival time are to be output due to transcoding, as well as a case in which different videos are synchronized.

The systems and or apparatuses described herein may be implemented using hardware components, software components, and/or a combination thereof. For example, a processing device (e.g., the electronic device 300, the live broadcast server 310, the video transmission server 320, and the event transmission server 330) may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

Methods according to example embodiments may be recorded in non-transitory computer-readable record media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable record media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing description has been provided for purposes of illustration and description. It is not intended to be exhaustive or to limit example embodiments of the present disclosure. Individual elements or features of a particular example embodiment are generally not limited to that particular embodiment, but where applicable, are interchangeable and can be used in other example embodiments, even if not specifically shown or described. The same may also be varied in many ways. Such variations are not to be regarded as a departure from the present disclosure, and all such modifications are intended to be included within the scope of the disclosure.

What is claimed is:

1. A data synchronization method performed by a computer system including at least one processor configured to execute computer readable instructions included in a memory, the data synchronization method comprising:
receiving, by the at least one processor, first data and second data from a server through real-time streaming, the second data being associated with the first data;
synchronizing, by the at least one processor, the first data and the second data using a timestamp included in the first data; and
outputting, by the at least one processor, the synchronized first and second data.

2. The data synchronization method of claim 1, wherein
the timestamp is included in timed metadata defined in the first data as an absolute time, and
a pop time in the second data for outputting the second data corresponds to the timestamp.

3. The data synchronization method of claim 2, wherein the pop time is a value accounting for a compensation value according to a latency of the first data.

4. The data synchronization method of claim 1, further comprising:
performing, by the at least one processor, a time synchronization with the server by receiving an absolute time from the server, the absolute time being a reference time for synchronizing the first data and the second data.

5. The data synchronization method of claim 1, wherein the outputting outputs the second data regardless of the first data, in response to a time gap between a first point in time at which the first data is received and a second point in time at which the second data is received reaching a critical time.

6. The data synchronization method of claim 5, wherein the critical time is in the second data and indicates a due time for outputting the second data.

7. The data synchronization method of claim 1, wherein the synchronizing comprises:
periodically requesting the server for synchronization of the first data; and
receiving a refresh request for the first data from the server as a response to the periodically requesting.

8. The data synchronization method of claim 1, wherein the synchronizing further comprises:
receiving a refresh request in response to a time gap between the first data transmitted to the server and the first data recently received by the at least one processor from the server being greater than or equal to a critical time.

9. A data synchronization method performed by a computer system including at least one processor configured to execute computer-readable instructions included in a memory, the data synchronization method comprising:
receiving, by the at least one processor, a video stream and event data associated with the video stream from a server through real-time streaming;
synchronizing, by the at least one processor, the video stream and the event data using a timestamp included in the video stream; and
outputting, by the at least one processor, a result of the synchronizing the video stream and the event data.

10. The data synchronization method of claim 9, wherein in a network environment with a pulling structure of downloading the video stream and the event data from the server, the outputting outputs an event layer that includes the event data in response to play of the video stream reaching the timestamp.

11. The data synchronization method of claim 9, wherein
the timestamp is included in timed metadata defined in the video stream as an absolute time, and
a pop time in the event data for outputting the event data corresponds to the timestamp.

12. The data synchronization method of claim 9, wherein the synchronizing and outputting the video stream and the event data comprises:
outputting the event data regardless of the video stream, in response to a time gap between a first point in time at which the video stream is received and a second point in time at which the event data is received reaching a critical time that is in the event data.

13. A non-transitory computer-readable record medium storing instructions that, when executed by the at least one processor, cause the at least one processor to perform the data synchronization method of claim 1.

14. A computer system comprising:
a memory; and
at least one processor configured to connect to the memory and execute computer-readable instructions included in the memory,
wherein the at least one processor is configured to,
receive first data and second data associated with the first data from a server through real-time streaming, and
synchronize the first data and the second data using a timestamp included in the first data, and
output the synchronized first and second data.

15. The computer system of claim 14, wherein
the timestamp is included in timed metadata defined in the first data as an absolute time, and
a pop time in the second data for outputting the second data corresponds to the timestamp.

16. The computer system of claim 15, wherein the pop time is a value accounting for a compensation value according to a latency of the first data.

17. The computer system of claim 14, wherein the at least one processor is further configured to perform a time synchronization with the server by receiving an absolute time from the server, the absolute time being a reference time for synchronizing the first data and the second data.

18. The computer system of claim 14, wherein the at least one processor is further configured to output the second data regardless of the first data, in response to a time gap between a first point in time at which the first data is received and a second point in time at which the second data is received reaching a critical time.

19. The computer system of claim 18, wherein the critical time is in the second data indicating a due time for outputting the second data.

20. The computer system of claim 14, wherein the at least one processor is further configured to perform,
periodically requesting the server for synchronization of the first data, and
receiving a refresh request for the first data from the server as a response to the periodically requesting, in response to a time gap between the first data transmitted to the server and the first data recently received by the at least one processor from the server being greater than or equal to a critical time.
